(19) United States
(12) Patent Application Publication
(10) Pub. No.: US 2003/0138064 A1
(43) Pub. Date: Jul. 24, 2003

(54) Method of estimating a radio frequency offset based on sequences of predefined symbols, and receiver implementing said method

(76) Inventors: Zied Malouche, Paris (FR); Nidham Ben Rached, Paris (FR)

Correspondence Address: PIPER RUDNICK, P. O. BOX 64807, CHICAGO, IL, 60664-0807, US

(21) Appl. No.: 10/204,615

(22) PCT Filed: Feb. 23, 2001
(86) PCT No.: PCT/FR01/00537

(30) Foreign Application Priority Data
Feb. 25, 2000 (FR) 00 02398

(51) Int. Cl. H04L 27/06

(52) U.S. Cl. 375/344

(57) ABSTRACT

The invention concerns a method for estimating an offset between a radio frequency used by a receiver to form a baseband signal from a radio signal segment received through a communication channel and a carrier frequency of the radio signal of the segment. The radio signal segment is produced by a transmitter from a block of modulating symbols including at least two sequences of predefined symbols separated by information symbols. It consists in generating a frequency offset estimate on the basis of at least two sequences of baseband signal samples corresponding to two sequences of the block predefined symbols.

The present invention relates to digital radio communications. It is more especially concerned with estimating the frequency offsets which may exist between a radio frequency used by a receiver to demodulate a signal received and the carrier of this signal.

Such frequency offsets may be due to the slightly different characteristics of the frequency synthesizers with which the transmitter and the receiver are equipped, or to the carrier frequency drift introduced by the radio wave propagation channel, in particular due to the Doppler effect.

In a high throughput transmission context, it is desired to economize on the bandwidth, hence the data transmitted are weakly protected by the channel coding processes. This is the case especially for the EGPRS packet mode (“EDGE Global Packet Radio Service”, EDGE standing for “Enhanced Data for GSM Evolution”) provided in order to enhance the second-generation cellular radio telephony systems of GSM type (“Global System for Mobile communications”) and derivatives. In such cases, a frequency difference or offset, even a small one, gives rise to residual errors which are unacceptable insofar as they cause appreciable degradation of the reception performance. The higher the frequency band, the greater is this degradation. It can be avoided by eliminating the frequency offset by estimation and correction.

A particular, non-limiting application of the invention is in burst mode radio communications systems with time-division multiplexing of the channels (TDMA, “Time Division Multiple Access”).

A TDMA radio signal burst is formed by modulating a transmission carrier by means of a digital signal block which usually comprises a training sequence composed of predefined symbols, which the receiver utilizes in particular to estimate the response of the propagation channel (operation referred to as channel probing). The time structure of the radio signal transmitted on the carrier is composed of successive frames subdivided into timeslots. A communication channel is typically formed by allotting a given timeslot in each frame, each timeslot being capable of containing a burst.

The existing processes for estimating the frequency offset at the receiver end generally use the samples of the baseband signal which correspond to the training sequence. The estimations thus obtained for several bursts pertaining to the same communication channel are filtered in order to increase the signal-to-noise ratio.

However, in the example of the context of high throughput packet mode transmission, several mobile terminals can use the same timeslot, so that the receiver's signal processing module no longer maps the received bursts onto the various transmitters. Therefore, the filtering of the estimations over several bursts becomes difficult to achieve, and a solution operating burst-by-burst is necessary.

However, when the frequency offset is small, typically of the order of about 100 hertz, the consideration of the samples corresponding to the training sequence is not sufficient to provide a reliable estimate for each individual burst (this is the reason why the aforesaid filtering is generally performed). The estimation of the frequency offset relies on a measurement of the phase rotation caused by this offset over the duration of the training sequence. This phase rotation is small since the training sequence should not be too long to avoid penalizing the bandwidth. Under these conditions, a consequence of the noise affecting the measurement is that the variance of the estimator is relatively high.

Another case where burst-by-burst estimation can be very useful is that of frequency hopping TDMA systems in which the communication frequency changes from one burst to another.

EP-A-0 950 568 and U.S. Pat. No. 5,245,611 describe other frequency offset estimation processes based on feedback with the aid of the symbols estimated by the channel equalizer. These processes provide more reliable estimations than the aforesaid direct processes, but they have the drawback of high complexity and hence of considerable cost in terms of digital processing capacity.

An object of the present invention is to propose a reliable frequency offset estimator, which in particular is capable of providing good estimations on the scale of a TDMA radio signal burst without requiring feedback on the part of a channel equalizer.

The invention thus proposes a method of estimating a frequency offset between a radio frequency used by a receiver to form a baseband signal from a radio signal segment received along a communication channel and a carrier frequency of the radio signal of the segment, the radio signal segment being produced by a transmitter from a block of modulating symbols including at least two sequences of predefined symbols separated by information symbols. Before applying an equalization processing to the baseband signal so as to estimate the information symbols, at least one parameter is generated for estimating the frequency offset on the basis of at least two sequences of samples of the baseband signal corresponding to two sequences of predefined symbols of the block.

The signal utilized to estimate the frequency offset extends over a relatively large duration since it covers a certain number of samples representing information symbols in addition to the sequences of predefined symbols. The larger phase rotation due to the frequency offset over this duration reduces the variance of the estimation.

The method makes it possible to estimate the frequency offset jointly with the estimation of the impulse response of the channel and thereafter to correct this offset, thus making it possible to probe the channel once the correction has been introduced.

The method is applicable to any mode of radio transmission and of channel multiplexing.

In one embodiment, the communication channel is time division multiplexed, a radio signal segment received then consisting of a radio signal burst.

The parameter for estimating the frequency offset may be generated to process each radio signal burst individually, hence the method is well suited to the packet mode.

However, by virtue of the decrease in the variance, the method also makes it possible to improve the estimations made when the receiver is capable of identifying a set of radio signal segments successively received from a given transmitter along the communication channel, i.e. in particular when its signal processing module knows the burst-mobile correspondence (packet mode with knowledge of the origin of the processed bursts, or circuit mode) in a TDMA application. In this case, the receiver filters the parameters for estimating the frequency offset successively generated for the segments or bursts of the set, so as to produce a smoothed estimation of the frequency offset, which it can use to process the radio signal of these segments.

In a particular embodiment of the method, where the baseband signal received is sampled at a frequency equal to Q times the frequency of the symbols of the block, Q being an integer equal to or greater than 1, and where the block comprises N symbols with positions 0 to N−1, with a first sequence of K(1) predefined symbols beginning from the position P(1), a start sequence of K(0) predefined symbols beginning from the position 0 and an end sequence of K(2) predefined symbols beginning from the position P(2)=N−K(2), where K(0), K(1), K(2) and P(1) are integers such that K(0)≧0, K(2)≧0, K(0)+K(2)>0, K(1)>L and P(1)≧K(0), L being a predetermined positive integer, the baseband signal comprises a first vector S₁ of QK(1)−L complex samples corresponding to the first sequence, a start vector S₀ of QK(0) complex samples corresponding to the start sequence and an end vector S₂ of QK(2) complex samples corresponding to the end sequence.

The parameter \hat{φ} for estimating the frequency offset can then be obtained according to

$$\hat{φ} = \frac{b}{a} ( 1 - \sqrt{1 + \frac{2 ac}{{b}^{2}}} ) ,$$

with:

$$\begin{matrix}a = {\sum }_{k = 1}^{QK ( 1 ) - L} ( {\sum }_{i = 1}^{QK ( 0 )} {( i - k - P ( 1 ) - L )}^{2} {β}_{0}^{i , k} + {\sum }_{i = 1}^{k - 1} {( i - k )}^{2} {β}_{1}^{i , k} + \\ {\sum }_{i = 1}^{QK ( 2 )} {( i - k + P ( 2 ) - P ( 1 ) )}^{2} {β}_{2}^{i , k} ) \\ b = {\sum }_{k = 1}^{QK ( 1 ) - L} ( {\sum }_{i = 1}^{QK ( 0 )} ( i - k - P ( 1 ) - L ) {α}_{0}^{i , k} + {\sum }_{i = 1}^{k - 1} ( i - k ) {α}_{1}^{i , k} + \\ {\sum }_{i = 1}^{QK ( 2 )} {( i - k + P ( 2 ) - P ( 1 ) )}^{2} {α}_{2}^{i , k} ) \\ c = {\sum }_{k = 1}^{QK ( 1 ) - L} ( {\sum }_{i = 1}^{QK ( 0 )} {β}_{0}^{i , k} + {\sum }_{i = 1}^{k - 1} {β}_{1}^{i , k} + {\sum }_{i = 1}^{QK ( 2 )} {β}_{2}^{i , k} )\end{matrix}$$

where, for m=0, 1 or 2, αₘ^{i,k} et βₘ^{i,k} are real numbers such that

$${R}_{m}^{i , k} {S}_{1}^{k} {S}_{m}^{i *} = {α}_{m}^{i , k} + j {β}_{m}^{i , k} , {R}_{m}^{i , k}$$

Rₘ^{i,k} is a predetermined complex coefficient, Sₘⁱ designates the i-th sample of the vector Sₘ and (.)* the complex conjugate.

Alternatively, the parameters for estimating the frequency offset can comprise the three coefficients a, b and c defined hereinabove. These coefficients can be filtered to obtain respective smoothed coefficients \overline{a}, \overline{b} and \overline{c} as a function of which a smoothed estimation is produced through a similar formula.

It should be noted that the aforesaid “first sequence” may possibly be situated at the start of the block (K(0)=P(1)=0) or at the end of the block (K(2)=0, P(1)+K(1)=N).

Another aspect of the present invention relates to a radio communication receiver, adapted for receiving radio signal segments along a communication channel, each segment being produced by a transmitter from a block of modulating symbols comprising at least two sequences of predefined symbols separated by information symbols. The receiver comprises a radio stage forming a baseband signal from each radio signal segment received along the communication channel, means for estimating a frequency offset between a radio frequency used for a segment in the radio stage and a carrier frequency of the radio signal of said segment, and equalization means for processing the baseband signal so as to estimate the information symbols. The means for estimating the frequency offset are arranged to generate at least one parameter for estimating the frequency offset, upstream of the equalization means, on the basis of at least two sequences of samples of the baseband signal corresponding to two sequences of predefined symbols of the block.

Other features and advantages of the present invention will become apparent in the description below of non-limiting exemplary embodiments, with reference to appended drawings, in which:

FIG. 1 is a chart showing the structure of a block of digital symbols from which a GSM signal burst is constructed;

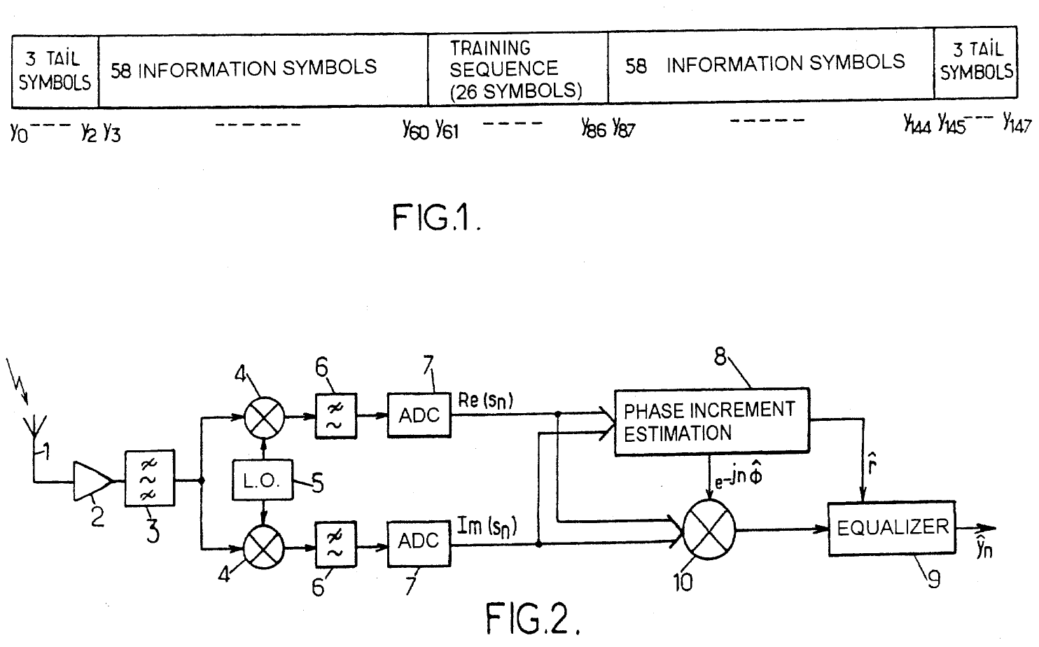

FIG. 2 is a schematic diagram of a receiver according to the invention;

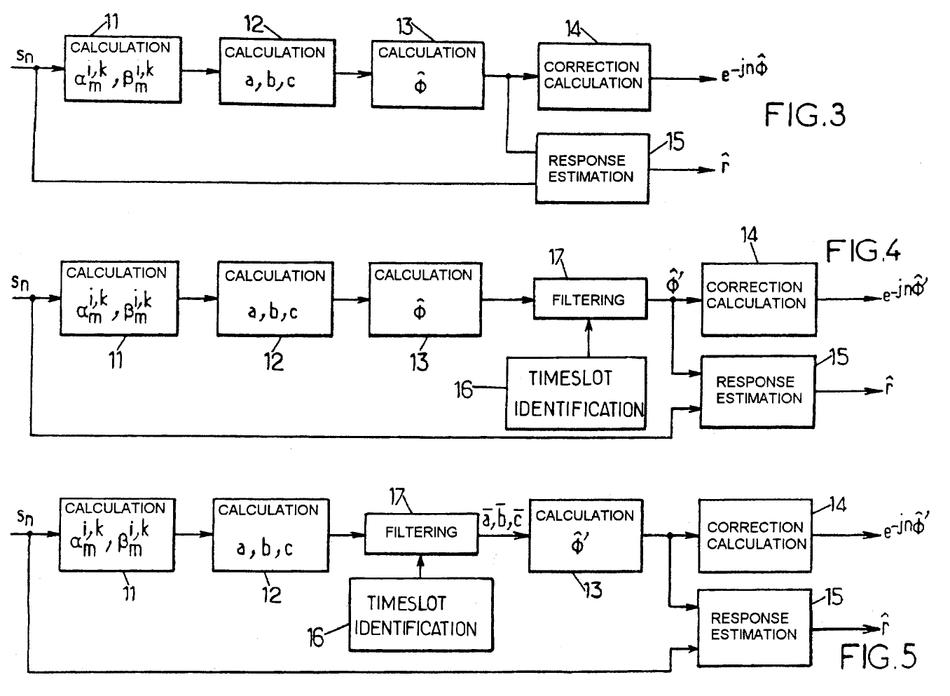

FIGS. 3 to 5 are schematic diagrams of three embodiments of an estimation module of the receiver of FIG. 2.

The general case is considered of a radio signal segment generated by a transmitter from a block of N modulating symbols y₀, y₁, . . . , Y_{N-1} having discrete values, for example yᵢ=±1 (binary symbols) or yᵢ=±1±j (quaternary symbols), etc. The block comprises several sequences of a priori known symbols. In the notation used here, the block will be regarded as comprising:

a sequence of K(0)≧0 known bits y_{P(0)}, . . . , y_{P(0)+K(0)-1} situated at the start of the block, i.e. P(0)=0;

a sequence of K(J)≧0 known bits y_{P(J)}, . . . , y_{P(J)+K(J)-1} situated at the end of the block, i.e. P(J)+K(J)=N;

J−1 sequences of respectively K(1), . . . , K(J−1) known bits, commencing respectively at positions P(1), . . . , P(J−1), with J>0 (J>1 if K(0)=0 or K(J)=0, and J>2 if K(0)=K(J)=0), and for 1≦m≦J, K(m)>0 and P(m)>P(m−1)+K(m−1), the known bits of sequence m being y_{P(m)}, . . . , y_{P(m)+K(m)-1}.

Between these sequences, the block contains information symbols a priori unknown.

In the case of the traffic channels of the GSM system, the ETSI (European Telecommunications Standards Institute) specifications fix the following parameters for a segment consisting of a burst transmitted in a TDMA timeslot: N=148, J=1, K(0)=K(2)=3, K(1)=26 and P(1)=61 (see FIG. 1). The central sequence of 26 symbols is the training sequence conventionally used by the receiver to synchronize itself and to estimate the impulse response of the channel. The two three-symbol sequences situated at the ends of the block (“tail symbols”) are substantially shorter than the training sequence and serve to fix the conditions at the boundaries of the trellis of the channel equalizer. The symbols are real (binary) in the case of GMSK (“Gaussian Minimum Shift Keying”) modulation used in particular for the telephony service, and complex (8-ary) in the case of EDGE modulation. The symbols of the training sequence are identical (real) in the GMSK and EDGE cases.

It is further assumed that the receiver samples the baseband signal received sₙ at a sampling frequency fₑ equal to Q times the frequency of the symbols, with Q integer equal to or greater than 1, and that the support of the impulse response of the channel (including the inter-symbol interference of the modulation) extends over the duration of L+1 samples (L≧0). The complex samples of this impulse response are denoted rₖ with rₖ=0 for k<0 and k>L. The response is represented by a vector r=(r₀, r₁, . . . , r_{L})^{T} (the notation (.)^{T} designates transposition).

By taking account of the frequency offset εf₀ (f₀ designates the carrier frequency and δ the offset expressed relative to f₀), the linear representation of the synchronized and sampled signal received can be written in the form:

$${s}_{n} = {ⅇ}^{j n φ} {\sum }_{k = 0}^{QN - 1} {x}_{k} {r}_{n - k} + {N}_{n} \qquad ( 1 )$$

In expression (1), the xₖ's (0≦k<QN) designate the sampled symbols of the block, i.e. xₖ=yᵢ for 0≦i<N and iQ≦k<(i+1)Q, Nₙ represents Gaussian additive white noise and φ a normalized phase increment proportional to the frequency offset, defined by φ=2πδf₀/fₛ.

In certain cases, multiple reception is performed with the help of one or more antennas so as to improve the performance by diversity. Typically, the samples emanating from several diversity paths are synchronized and then summed. In such a case, the signal received sₙ considered here, having the expression (1), can consist of the summed samples.

One seeks to construct an estimator \hat{φ} of the phase increment φ, this amounting to estimating the frequency offset, by using only the samples of the current segment and with the smallest possible variance. This is possible if the number of samples involved and the distance between the first and the last of these samples are large.

The phase rotation due to the frequency offset between the first and last symbol of the training sequence is 25φin the case of GSM systems and derivatives. In the presence of a small frequency offset, this rotation is so small that it becomes difficult to estimate: the variance of the estimator increases dramatically, thereby worsening the performance of the receiver. For example, for a 45 Hz offset, the phase rotation over the training sequence is 1.5° in GSM 900 (900 MHz band) and 3° in DCS 1800 (variant in a 1800 MHz band). Taking into account the “tail symbols” in accordance with the invention makes it possible to measure a phase rotation due to the frequency offset between the first and the last symbol of 147φ, and hence to greatly decrease the variance of the estimator. In the example of the 45 Hz offset, the rotation is 8.8° in GSM 900 and 17.6° in DCS 1800.

We consider hereafter the non-limiting example of a TDMA type of radio communication system, the segment considered being a burst transmitted in a timeslot.

For 0≦k<QN+L, u(k) denotes the vector defined for a burst by: u(k)^{T}=(xₖ, xₖ₋₁, . . . , x_{k-L}), with x_{-L}= . . . =x₋₁=0 and x_{QN}= . . . =x_{QN+L-1}=0, and we define J+1 Toeplitz matrices Mₘ with L+1 columns, which depend only on the symbols known a priori:

$${M}_{0} = {[ u ( 0 ) , u ( 1 ) , … , u ( QK ( 0 ) - 1 ) ]}^{T} , with QK ( 0 ) rows ; for 1 \leq m < J : {M}_{m} = [ u ( QP ( m ) + L ) {, [ u ( QP ( m ) + L + 1 ) , … , u ( QP ( m ) + QK ( m ) - 1 ) ]}^{T} , with QK ( m ) - L rows ; \\ {M}_{j} = {[ u ( QP ( J ) + L ) , u ( QP ( J ) + L + 1 ) , … , u ( QN + L - 1 ) ]}^{T} , with QK ( J ) rows .$$

Moreover we define J+1 vectors Sₘ composed of the complex samples of the baseband signal received which correspond to the known symbols:

S₀=(s₀, s₁, . . . , s_{QK(0)-1})^{T}, of size QK(0);

for 1≦m<J: Sₘ=(s_{QP(m)+L}, s_{QP(m)+L+1}, . . . , s_{QP(m)-1})^{T}, of size

QK(m)−L;

Sⱼ=(S_{QP(J)+L}, s_{QP(J)+L+1}, . . . , s_{QN+L-1})^{T} of size QK(J).

We note

$$γ = ( \frac{QN + L - 1}{2} )$$

and, for any integer Z, D_{Z}=diag[1, e^{jφ}, e^{2jφ}, . . . , e^{j(Z-1)φ}], the diagonal square matrix of size Z×Z whose respective diagonal terms are 1, e^{jφ}, e^{2jφ}, . . . , e^{j(Z-1})φ. For 0≦m≦J, we define diagonal matrices Φₘ and Δₘ as follows:

$${Φ}_{0} = {ⅇ}^{- jγφ} \cdot {D}_{QK ( 0 )} and {Δ}_{0} = diag [ - γ , - γ + 1 , … , - γ + QK ( 0 ) - 1 ] , each of size QK ( 0 ) \times QK ( 0 ) ; for 1 \leq m < J : {Φ}_{m} = {ⅇ}^{j ( - γ + QP ( m ) + L ) φ} \cdot {D}_{QK ( m ) - L } and {Δ}_{m} = diag [ - γ + QP ( m ) + L , - γ + QP ( m ) + L + 1 , … , - γ + QP ( m ) + QK ( m ) - 1 ] , each of size ( QK ( m ) - L ) \times ( QK ( m ) - L ) ; {Φ}_{J} = {ⅇ}^{j ( - γ + QP ( J ) + L ) φ} \cdot {D}_{QK ( J )} {Δ}_{J} = diag [ - γ + QP ( J ) + L , - γ + QP ( J ) + L + 1 , … , - γ + QN + L - 1 ] , each of size QK ( J ) \times QK ( J ) .$$

By considering only the known symbols of the block, model (1) gives J+1 linear systems which may each be written, to within a phase, in matrix form:

Sₘ=ΦₘMₘr+Nₘ (2)

where Nₘ is a vector of Gaussian noise.

The application of the least squares criterion to these J+1 linear systems leads to the following relations (3) and (4), which are satisfied by the estimation \hat{r} of the impulse response vector r and those \hat{Φ}ₘ of the matrices Φₘ dependent on the phase increment φ:

$$\begin{matrix}( {\sum }_{m = 0}^{J} {M}_{m}^{H} {M}_{m} ) \hat{r} = {\sum }_{m = 0}^{J} {M}_{m}^{H} {\hat{Φ}}_{m}^{H} {S}_{m} & ( 3 ) \\ {\sum }_{m = 0}^{J} ( {S}_{m}^{H} {\hat{Φ}}_{m} {Δ}_{m} {M}_{m} \hat{r} - {\hat{r}}^{H} {M}_{m}^{H} {Δ}_{m} {\hat{Φ}}_{m}^{H} {S}_{m} ) = 0 & ( 4 )\end{matrix}$$

where (.)^{H} represents the conjugate transpose. Relation (3) yields a \hat{100}-dependent estimation \hat{r}:

$$\hat{r} = {( {\sum }_{m = 0}^{J} {M}_{m}^{H} {M}_{m} )}^{- 1} ( {\sum }_{M = 0}^{J} {M}_{m}^{H} {\hat{Φ}}_{m}^{H} {S}_{m} ) \qquad ( 5 )$$

which, fed back into relation (4), leads to:

$${\sum }_{m = 0}^{J} [ {S}_{m}^{H} {\hat{Φ}}_{m} {R}_{m , m} {\hat{Φ}}_{m}^{H} {S}_{m} + 2 j \cdot lm \{ {\sum }_{p = m + 1}^{J} {S}_{m}^{H} {\hat{Φ}}_{m} {R}_{m , p} {\hat{Φ}}_{p}^{H} {S}_{p} \} ] = 0 \qquad ( 6 )$$

where Im{.} represents the imaginary part of a complex number. The J(J+1)/2 matrices R_{m.p} of relation (6), given by R_{m,p}=ΔₘMₘPMₚ^{H}−MₘP^{H}M^{p}^{H}Δₚ with

$$P = {( {\sum }_{m = 0}^{J} {M}_{m}^{H} {M}_{m} )}^{- 1} ,$$

may be calculated once for all and stored by the receiver for 0≦m≦p≦j.

An optimal estimator \hat{φ} for the current burst can be calculated by the receiver by searching for a zero of relation (6) after having acquired the samples of the vectors Sₘ. Of course, the more correct the synchronization of the receiver, i.e. the more the most important echoes of the channel have been included, the more reliable this estimator will be.

The above optimal estimator uses a channel probing performed on the basis of the set of a priori known sequences. When a burst comprises a single training sequence (J−1=1) and one or two short sequences of “tail symbols” at the start and at the end of the block, a less complex solution consists in probing the channel on the basis of the training sequence alone. This solution is only slightly suboptimal since the samples of the vectors S₀ and S₂ relating to the “tail symbols”, which are relatively few in number, do not enhance the probing statistics much, while they appreciably decrease the variance of the estimator of the phase increment, given that they span the entire length of the burst.

This last solution consists in making the following approximation in relation (5):

$$\hat{r} = {( {M}_{1}^{H} {M}_{1} )}^{- 1} {M}_{1}^{H} {\hat{Φ}}_{1}^{H} {S}_{1} \qquad ( 7 )$$

The estimation according to the least squares criterion then gives:

$$2 j \cdot Im \{ {S}_{0}^{H} {\hat{Φ}}_{0} {R}_{0} {\hat{Φ}}_{1}^{H} {S}_{1} + {S}_{2}^{H} {\hat{Φ}}_{2} {R}_{2} {\hat{Φ}}_{1}^{H} {S}_{1} \} + {S}_{1}^{H} {\hat{Φ}}_{1} {R}_{1} {\hat{Φ}}_{1}^{H} {S}_{1} = 0 \qquad ( 8 )$$

where: R₁=Δ₁P′−P′Δ₁, of size [QK(1)−L]×[QK(1)−L], with Id the identity matrix of rank L+1, and

$$\begin{matrix}{P}^{′} = {{M}_{1} ( {M}_{1}^{H} {M}_{1} )}^{- 1} ( {M}_{0}^{H} {M}_{0} + {M}_{2}^{H} {M}_{2} - Id ) {( {M}_{1}^{H} {M}_{1} )}^{- 1} {M}_{1}^{H} ; \\ {R}_{m} = {{M}_{m} ( {M}_{1}^{H} {M}_{1} )}^{- 1} {M}_{1}^{H} {Δ}_{1} - {Δ}_{m} {{M}_{m} ( {M}_{1}^{H} {M}_{1} )}^{- 1} {M}_{1}^{H} for m = \\ 0 and 2 , of size QK ( m ) \times [ QK ( 1 ) - L ] .\end{matrix}$$

By observing that the diagonal terms of the matrix R₁ are all zero and that R₁=−R₁^{H}, relation (8) simplifies:

$${\sum }_{k = 1}^{QK ( 1 ) - L} Im \{ {S}_{1}^{k} {ⅇ}^{- j k \hat{φ}} ( {\sum }_{i = 1}^{QK ( 0 )} {R}_{0}^{i , k} {S}_{0}^{{i}^{*}} {ⅇ}^{j ( i - L ) \hat{φ}} + {\sum }_{i = 1}^{k - 1} {R}_{1}^{i , k} {S}_{1}^{{i}^{*}} {ⅇ}^{j ( P ( 1 ) + i ) \hat{φ}} + {\sum }_{i = 1}^{QK ( 2 )} {R}_{2}^{i , k} {S}_{2}^{{i}^{*}} {ⅇ}^{j ( P ( 2 ) + i ) \hat{φ}} ) \} = 0 \qquad ( 9 )$$

where Rₘ^{i,k} designates the term situated in the i-th row and k-th column of the matrix Rₘ (°≦M≦2), and Sₘⁱ the i-th component of the vector Sₘ (Sₘⁱ=s_{i-1+P(m)}) The Rₘ^{i,k} are fixed coefficients calculated in advance, while the Sₘⁱ are acquired on receipt of the signal.

Equations (6) and (9) are nonlinear in \hat{φ} and possess several roots. The correct root is the one closest to zero. Equation (6) or (9) can be solved by several interactive processes for searching for roots of trigonometric polynomials. In practice, the possible frequency offsets are fairly small (less than 270 Hz in the case of GSM), so that the normalized phase increment φ is always very small compared with 1, thereby justifying the second-order approximation e^{jα\hat{φ}}≈1+jα\hat{φ}−α²\hat{φ}²/2, giving rise to an estimate which can be easily calculated directly:

$$\hat{φ} = \frac{b}{a} ( 1 - \sqrt{1 + \frac{2 a c}{{b}^{2}}} ) \qquad ( 10 )$$

with, in the case of relation (9):

$$\begin{matrix}a = {\sum }_{k = 1}^{QK ( 1 ) - L} ( {\sum }_{i = 1}^{QK ( 0 )} {( i - k - P ( 1 ) - L )}^{2} {β}_{0}^{i , k} + {\sum }_{i = 1}^{k - 1} {( i - k )}^{2} {β}_{1}^{i , k} + {\sum }_{i = 1}^{QK ( 2 )} {( i - k + P ( 2 ) - P ( 1 ) )}^{2} {β}_{2}^{i , k} ) \\ b = {\sum }_{k = 1}^{QK ( 1 ) - L} ( {\sum }_{i = 1}^{QK ( 0 )} ( i - k - P ( 1 ) - L ) {α}_{0}^{i , k} + {\sum }_{i = 1}^{k - 1} ( i - k ) {α}_{1}^{i , k} + {\sum }_{i = 1}^{QK ( 2 )} {( i - k + P ( 2 ) - P ( 1 ) )}^{2} {α}_{2}^{i , k} ) \\ c = {\sum }_{k = 1}^{QK ( 1 ) - L} ( {\sum }_{i = 1}^{QK ( 0 )} {β}_{0}^{i , k} + {\sum }_{i = 1}^{k - 1} {β}_{1}^{i , k} + {\sum }_{i = 1}^{QK ( 2 )} {β}_{2}^{i , k} )\end{matrix}$$

where αₘ^{i,k} and βₘ^{i,k} are the real numbers such that

$${R}_{m}^{i , k} {S}_{1}^{k} {S}_{m}^{{i}^{*}} = {α}_{m}^{i , k} + j {β}_{m}^{i , k} .$$

Once the samples sₙ corresponding to the known sequences of the symbol block of the received baseband signal are available, the αₘ^{i,k} and βₘ^{i,k}, the coefficients a, b and c and then the estimation \hat{φ} of the phase increment, which is proportional to the frequency offset, can be calculated directly.

The receiver represented in FIG. 2, which can in particular be a GSM receiver (mobile station or base station), comprises an antenna 1 picking up a radio signal submitted to a radio reception stage comprising an amplifier 2, a bandpass filter 3 and two mixers 4 receiving the amplified and filtered radio signal. A local oscillator 5 delivers two quadrature radio waves at the frequency of the communication channel employed by the receiver. The mixers 4 multiply these two waves by the amplified and filtered radio signal, and the resulting signals are provided to low-pass filters 6 and then to analog/digital converters 7 operating at the sampling frequency fₑ. The output signals from the converters 7 constitute the real and imaginary parts of the complex baseband signal sₙ.

This signal sₙ may exhibit a phase drift if the frequency of the local oscillator 5 does not correspond exactly to the carrier of the radio signal picked up. It is to correct this drift that the estimator of the frequency offset is used.

The estimation of the phase increment φ is performed by a module 8, for example by using relation (10) above. Alternatively, the module 8 can operate by applying an iterative calculation process.

The module 8 delivers the estimation \hat{φ}, obtained for example according to relation (10), for each signal burst with a view to the equalization processing applied to this burst by the channel equalizer 9. A complex multiplier 10 corrects the samples sₙ of the burst at the input of the equalizer 9 by multiplying them by the complex number e^{-jn\hat{φ}} (provided by the module 8 (correction of the exponential term of relation (1)).

The estimation of the impulse response of the channel can be performed on the basis of the corrected samples of the baseband signal or, as represented in FIG. 2, jointly with the estimation of the frequency offset by the module 8. This estimation \hat{r} can be obtained by applying relation (5), where the matrix

$${( {\sum }_{m = 0}^{J} {M}_{m}^{H} {M}_{m} )}^{- 1}$$

has been calculated once for all and stored in module 8, or according to relation (7), where the matrix (M₁^{H}M₁)⁻¹ M₁^{H} has been calculated once for all and stored in module 8.

The equalizer 9 can thereafter, in a conventional manner, estimate the symbols ŷₙ of the block corresponding to the burst, with the aid of the corrected samples and of the estimation \hat{r}.

With reference to FIGS. 3 to 5, the coefficients a, b and c of formula (10) are calculated for the current burst from the complex signal sₙ, by way of the quantities αₘ^{i,k} and βₘ^{i,k}, by calculation modules 11, 12 belonging to the phase increment estimation module 8.

In the embodiments according to FIGS. 3 and 4, a module 13 calculates the estimation \hat{φ} relating to the current burst by applying formula (10).

In the case of FIG. 3, the estimation and the correction are performed individually for the various bursts. A module 14 calculates for the various samples n of the current burst the corrective terms e^{-jn\hat{φ}} provided to the multiplier 10, while the response r of the channel is estimated according to relation (7) by the module 15.

In the embodiments according to FIGS. 4 and 5, a module 16 makes it possible to identify whether the current burst originates from a given transmitter with which the receiver is communicating. This can be performed by signaling, the timeslots alotted to each transmitter forming the subject of an allocation. A filtering of the parameters for estimating the frequency offset is effected by a module 17 to produce temporally smoothed parameters. The filtering consists for example of an average over a sliding or exponential window, applied to the bursts originating from one and the same transmitter.

In the case of FIG. 4, the parameter filtered by the module 17 is the estimation \hat{φ} relating to the current burst, calculated by the module 13. The filtered estimation \hat{φ} produced by the module 17 is used by the modules 14 and 15 to correct the frequency offset and to estimate the channel.

In the case of FIG. 5, the parameters filtered by the module 17 are the coefficients a, b and c relating to the current burst, which are calculated by the module 12. The smoothed estimation \hat{φ}′ used by the modules 14 and 15 is obtained as a function of the smoothed parameters \overline{a}, \overline{b}, \overline{c} according to the formula:

$${\hat{φ}}^{′} = \frac{\overline{b}}{\overline{a}} ( 1 - \sqrt{1 + \frac{2 \overline{ a c}}{{\overline{b}}^{2}}} ) \qquad ( {10}^{′} )$$

1. A method of estimating a frequency offset between a radio frequency used by a receiver to form a baseband signal (sₙ) from a radio signal segment received along a communication channel and a carrier frequency of the radio signal of the segment, the radio signal segment being produced by a transmitter from a block of modulating symbols including at least two sequences of predefined symbols separated by information symbols, characterized in that before applying an equalization processing to the baseband signal so as to estimate the information symbols, at least one parameter (\hat{φ}; a, b, c) is generated for estimating the frequency offset on the basis of at least two sequences of samples of the baseband signal (Sₘ) corresponding to two sequences of predefined symbols of the block.

2. The method as claimed in claim 1, wherein the communication channel is time division multiplexed, whereby a received radio signal segment consists of a radio signal burst.

3. The method as claimed in claim 2, wherein the parameter (\hat{φ}) for estimating the frequency offset is generated to process each radio signal burst individually.

4. The method as claimed in any one of the preceding claims, comprising the steps of identifying a set of radio signal segments successively received from the transmitter along the communication channel and intended for the receiver, and filtering the parameters (\hat{φ}; a, b, c) for estimating the frequency offset successively generated for the segments of the set to produce a smoothed estimation (\hat{φ}′) of the frequency offset, used to process the radio signal of the segments of the set.

5. The method as claimed in any one of the preceding claims, wherein said sequences of predefined symbols comprise two sequences respectively situated at the start and at the end of the block of modulating symbols.

6. The method as claimed in any one of the preceding claims, wherein said sequences of predefined symbols comprise a first sequence and at least one second sequence situated at an end of the block of modulating symbols and substantially shorter than the first sequence.

7. The method as claimed in claim 6, wherein the parameter (\hat{φ}; a, b, c) for estimating the frequency offset is generated on the basis of the first sequence and of each second sequence, while the response of the communication channel is estimated on the basis of the first sequence alone.

8. The method as claimed in any one of the preceding claims, wherein the baseband signal (sₙ) is sampled at a frequency equal to Q times the frequency of the symbols of the block, Q being an integer equal to or greater than 1,
wherein the block comprises N symbols with positions 0 to N−1, with a first sequence of K(1) predefined symbols beginning from the position P(1), a start sequence of K(0) predefined symbols beginning from the position 0 and an end sequence of K(2) predefined symbols beginning from the position P(2)=N−K(2), where K(0), K(1), K(2) and P(1) are integers such that K(0)≧0, K(2)≧0, K(0)+K(2)>0, K(1)>L and P(1)≧K(0), L being a predetermined positive integer,
wherein the baseband signal comprises a first vector S₁ of QK(1)−L complex samples corresponding to the first sequence, a start vector S₀ of QK(0) complex samples corresponding to the start sequence and an end vector S₂ of QK(2) complex samples corresponding to the end sequence,
and wherein the parameter \hat{φ} for estimating the frequency offset is obtained according to
$$\hat{φ} = \frac{b}{a} ( 1 - \sqrt{1 + \frac{2 a c}{{b}^{2}}} ) ,$$
with:
$$a = {\sum }_{k = 1}^{QK ( 1 ) - L} ( {\sum }_{i = 1}^{QK ( 0 )} {( i - k - P ( 1 ) - L )}^{2} {β}_{0}^{i , k} + {\sum }_{i = 1}^{k - 1} {( i - k )}^{2} {β}_{1}^{i , k} {\sum }_{i = 1}^{QK ( 2 )} {( i - k + P ( 2 ) - P ( 1 ) )}^{2} {β}_{2}^{i , k} )$$
$$b = {\sum }_{k = 1}^{QK ( 1 ) - L} ( {\sum }_{i = 1}^{QK ( 0 )} ( i - k - P ( 1 ) - L ) {α}_{0}^{i , k} + {\sum }_{i = 1}^{k - 1} ( i - k ) {α}_{1}^{i , k} {\sum }_{i = 1}^{QK ( 2 )} {( i - k + P ( 2 ) - P ( 1 ) )}^{2} {α}_{2}^{i , k} )$$
$$c = {\sum }_{k = 1}^{QK ( 1 ) - L} ( {\sum }_{i = 1}^{QK ( 0 )} {β}_{0}^{i , k} + {\sum }_{i = 1}^{k - 1} {β}_{1}^{i , k} + {\sum }_{i = 1}^{QK ( 2 )} {β}_{2}^{i , k} )$$
where, for m=0, 1 or 2, αₘ^{i,k} et βₘ^{i,k} are real numbers such that Rₘ^{i,k}S₁^{k}Sₘ^{i*}=αₘ^{i,k}+jβₘ^{i,k}, Rₘ^{i,k} is a predetermined complex coefficient, Sₘⁱ designates the i-th sample of the vector Sₘ and (.)* the complex conjugate.

9. The method as claimed in any one of claims 1 to 7, wherein the baseband signal (sₙ) is sampled at a frequency equal to Q times the frequency of the symbols of the block, Q being an integer equal to or greater than 1,
wherein the block comprises N symbols with positions 0 to N−1, with a first sequence of K(1) predefined symbols beginning from the position P(1), a start sequence of K(0) predefined symbols beginning from the position 0 and an end sequence of K(2) predefined symbols beginning from the position P(2)=N−K(2), where K(0), K(1), K(2) and P(1) are integers such that K(0)≧0, K(2)≧0, K(0)+K(2)>0, K(1)>L and P(1)≧K(0), L being a predetermined positive integer,
wherein the baseband signal comprises a first vector S, of QK(1)−L complex samples corresponding to the first sequence, a start vector S0 of QK(0) complex samples corresponding to the start sequence and an end vector S₂ of QK(2) complex samples corresponding to the end sequence,
wherein the parameters for estimating the frequency offset comprise three coefficients a, b and c given by:
$$a = {\sum }_{k = 1}^{QK ( 1 ) - L} ( {\sum }_{i = 1}^{QK ( 0 )} {( i - k - P ( 1 ) - L )}^{2} {β}_{0}^{i , k} + {\sum }_{i = 1}^{k - 1} {( i - k )}^{2} {β}_{1}^{i , k} {\sum }_{i = 1}^{QK ( 2 )} {( i - k + P ( 2 ) - P ( 1 ) )}^{2} {β}_{2}^{i , k} )$$
$$b = {\sum }_{k = 1}^{QK ( 1 ) - L} ( {\sum }_{i = 1}^{QK ( 0 )} ( i - k - P ( 1 ) - L ) {α}_{0}^{i , k} + {\sum }_{i = 1}^{k - 1} ( i - k ) {α}_{1}^{i , k} {\sum }_{i = 1}^{QK ( 2 )} {( i - k + P ( 2 ) - P ( 1 ) )}^{2} {α}_{2}^{i , k} )$$
$$c = {\sum }_{k = 1}^{QK ( 1 ) - L} ( {\sum }_{i = 1}^{QK ( 0 )} {β}_{0}^{i , k} + {\sum }_{i = 1}^{k - 1} {β}_{1}^{i , k} + {\sum }_{i = 1}^{QK ( 2 )} {β}_{2}^{i , k} )$$
where, for m=0, 1 or 2, αₘ^{i,k} et βₘ^{i,k} are real numbers such that
$${R}_{m}^{i , k} {S}_{1}^{k} {S}_{m}^{{i}^{*}} = {α}_{m}^{i , k} + {jβ}_{m}^{i , k} , {R}_{m}^{i , k}$$
is a predetermined complex coefficient, Sₘⁱ designates the i-th sample of the vector Sₘ and (.)* the complex conjugate,
the method comprising the steps of identifying a set of radio signal segments successively received from the transmitter along the communication channel and intended for the receiver, and filtering the coefficients a, b and c to obtain respective smoothed coefficients \overline{a}, \overline{b} and \overline{c} as a function of which is produced a smoothed estimation
$${\hat{φ}}^{′} = \frac{\overline{b}}{\overline{a}} ( 1 - \sqrt{1 + \frac{2 \overline{a c}}{{\overline{b}}^{2}}} )$$
used to process the radio signal of the segments of the set.

10. A radio communication receiver, adapted for receiving radio signal segments along a communication channel, each segment being produced by a transmitter from a block of modulating symbols comprising at least two sequences of predefined symbols separated by information symbols, the receiver comprising a radio stage (2-7) forming a baseband signal (sₙ) from each radio signal segment received along the communication channel, means (8) for estimating a frequency offset between a radio frequency used for a segment in the radio stage and a carrier frequency of the radio signal of said segment, and equalization means (9) for processing the baseband signal to estimate the information symbols, characterized in that the means for estimating the frequency offset are arranged to generate a parameter (\hat{φ}; a, b, c) for estimating the frequency offset, upstream of the equalization means, on the basis of at least two sequences of samples of the baseband signal corresponding to two sequences of predefined symbols of the block.

11. The receiver as claimed in claim 10, wherein the communication channel is time division multiplexed, whereby a radio signal segment received consists of a radio signal burst.

12. The receiver as claimed in claim 11, further comprising means (9-10) for processing each radio signal burst by taking account of the parameter (\hat{φ}) for estimating the frequency offset generated individually for said burst by the estimation means (8).

13. The receiver as claimed in any one of claims 10 to 12, further comprising means (16) for identifying a set of radio signal segments successively received from the transmitter along the communication channel and intended for the receiver, and means (9-10) for processing the radio signal of the segments of the set by taking account of a smoothed estimation (\hat{φ}) of the frequency offset produced by the estimation means (8) by filtering the parameters (\hat{φ}; a, b, c) for estimating the frequency offset successively generated for the segments of the set.

14. The receiver as claimed in any one of claims 10 to 13, wherein said sequences of predefined symbols comprise two sequences respectively situated at the start and at the end of the block of modulating symbols.

15. The receiver as claimed in any of claims 10 to 14, wherein said sequences of predefined symbols comprise a first sequence and at least one second sequence situated at an end of the block of modulating symbols and substantially shorter than the first sequence.

16. The receiver as claimed in claim 15, wherein the means (8) for estimating the frequency offset are arranged to generate the estimation of the frequency offset on the basis of the first sequence and of each second sequence, the receiver further comprising means (15) for estimating the response of the communication channel on the basis of the first sequence alone.

17. The receiver as claimed in any one of claims 10 to 16, wherein the baseband signal (sₙ) is sampled at a frequency equal to Q times the frequency of the symbols of the block, Q being an integer equal to or greater than 1,
wherein the block comprises N symbols with positions 0 to N−1, with a first sequence of K(1) predefined symbols beginning from the position P(1), a start sequence of K(0) predefined symbols beginning from the position 0 and an end sequence of K(2) predefined symbols beginning from the position P(2)=N−K(2), where K(0), K(1), K(2) and P(1) are integers such that K(0)≧0, K(2)≧0, K(0)+K(2)>0, K(1)>L and P(1)≧K(0), L being a predetermined positive integer,
wherein the baseband signal comprises a first vector S₁ of QK(1)−L complex samples corresponding to the first sequence, a start vector S₀ of QK(0) complex samples corresponding to the start sequence and an end vector S₂ of QK(2) complex samples corresponding to the end sequence,
and wherein the parameter \hat{φ} for estimating the frequency offset is obtained by the estimation means (8) according to
$$\hat{φ} = \frac{b}{a} ( 1 - \sqrt{1 + \frac{2 a c}{{b}^{2}}} ) ,$$
with:
$$a = {\sum }_{k = 1}^{QK ( 1 ) - L} ( {\sum }_{i = 1}^{QK ( 0 )} {( i - k - P ( 1 ) - L )}^{2} {β}_{0}^{i , k} + {\sum }_{i = 1}^{k - 1} {( i - k )}^{2} {β}_{1}^{i , k} {\sum }_{i = 1}^{QK ( 2 )} {( i - k + P ( 2 ) - P ( 1 ) )}^{2} {β}_{2}^{i , k} )$$
$$b = {\sum }_{k = 1}^{QK ( 1 ) - L} ( {\sum }_{i = 1}^{QK ( 0 )} ( i - k - P ( 1 ) - L ) {α}_{0}^{i , k} + {\sum }_{i = 1}^{k - 1} ( i - k ) {α}_{1}^{i , k} {\sum }_{i = 1}^{QK ( 2 )} {( i - k + P ( 2 ) - P ( 1 ) )}^{2} {α}_{2}^{i , k} )$$
$$c = {\sum }_{k = 1}^{QK ( 1 ) - L} ( {\sum }_{i = 1}^{QK ( 0 )} {β}_{0}^{i , k} + {\sum }_{i = 1}^{k - 1} {β}_{1}^{i , k} + {\sum }_{i = 1}^{QK ( 2 )} {β}_{2}^{i , k} )$$
where, for m=0, 1 or 2, αₘ^{i,k} et βₘ^{i,k} are real numbers such that
$${R}_{m}^{i , k} {S}_{1}^{k} {S}_{m}^{{i}^{*}} = {α}_{m}^{i , k} + {jβ}_{m}^{i , k} , {R}_{m}^{i , k}$$
is a predetermined complex coefficient, Sₘⁱ designates the i-th sample of the vector Sₘ and (.)* the complex conjugate.

18. The receiver as claimed in any one of claims 10 to 16, wherein the baseband signal (sₙ) is sampled at a frequency equal to Q times the frequency of the symbols of the block, Q being an integer equal to or greater than 1,
wherein the block comprises N symbols with positions 0 to N−1, with a first sequence of K(1) predefined symbols beginning from the position P(1), a start sequence of K(0) predefined symbols beginning from the position 0 and an end sequence of K(2) predefined symbols beginning from the position P(2)=N−K(2), where K(0), K(1), K(2) and P(1) are integers such that K(0)≧0, K(2)≧0, K(0)+K(2)>0, K(1)≧L and P(1)≧K(0), L being a predetermined positive integer,
wherein the baseband signal comprises a first vector S₁ of QK(1)−L complex samples corresponding to the first sequence, a start vector S₀ of QK(0) complex samples corresponding to the start sequence and an end vector S₂ of QK(2) complex samples corresponding to the end sequence,
and wherein the parameters for estimating the frequency offset comprise three coefficients a, b and c obtained by the estimation means (8) according to:
$$a = {\sum }_{k = 1}^{QK ( 1 ) - L} ( {\sum }_{i = 1}^{QK ( 0 )} {( i - k - P ( 1 ) - L )}^{2} {β}_{0}^{i , k} + {\sum }_{i = 1}^{k - 1} {( i - k )}^{2} {β}_{1}^{i , k} {\sum }_{i = 1}^{QK ( 2 )} {( i - k + P ( 2 ) - P ( 1 ) )}^{2} {β}_{2}^{i , k} )$$
$$b = {\sum }_{k = 1}^{QK ( 1 ) - L} ( {\sum }_{i = 1}^{QK ( 0 )} ( i - k - P ( 1 ) - L ) {α}_{0}^{i , k} + {\sum }_{i = 1}^{k - 1} ( i - k ) {α}_{1}^{i , k} {\sum }_{i = 1}^{QK ( 2 )} {( i - k + P ( 2 ) - P ( 1 ) )}^{2} {α}_{2}^{i , k} )$$
$$c = {\sum }_{k = 1}^{QK ( 1 ) - L} ( {\sum }_{i = 1}^{QK ( 0 )} {β}_{0}^{i , k} + {\sum }_{i = 1}^{k - 1} {β}_{1}^{i , k} + {\sum }_{i = 1}^{QK ( 2 )} {β}_{2}^{i , k} )$$
where, for m=0, 1 or 2, αₘ^{i,k} et βₘ^{i,k} are real numbers such that
$${R}_{m}^{i , k} {S}_{1}^{k} {S}_{m}^{{i}^{*}} = {α}_{m}^{i , k} + {jβ}_{m}^{i , k} , {R}_{m}^{i , k}$$
is a predetermined complex coefficient, Sₘⁱ designates the i-th sample of the vector Sₘ and (.)* the complex conjugate,
the receiver further comprising means (16) for identifying a set of radio signal segments successively received from the transmitter along the communication channel and intended for the receiver and means (9-10) for processing the radio signal of the segments of the set by taking account of a smoothed estimation
$${\hat{φ}}^{′} = \frac{\overline{b}}{\overline{a}} ( 1 - \sqrt{1 + \frac{2 \overline{ac}}{{\overline{b}}^{2}}} )$$
of the frequency offset produced by the estimation means (8) as a function of smoothed coefficients \overline{a}, \overline{b} and \overline{c} calculated by filtering the coefficients a, b and c successively obtained by the estimation means (8) for the segments of the set.
